(19) United States
(12) Patent Application Publication
(10) Pub. No.: US 2020/0066442 A1
(43) Pub. Date: Feb. 27, 2020

(54) FERRITE-CORE FIXING STRUCTURE AND METHOD FOR MANUFACTURING THE SAME

(71) Applicant: Murata Manufacturing Co., Ltd., Nagaokakyo-shi (JP)

(72) Inventors: Yoshihiro Yamaguchi, Nagaokakyo-shi (JP); Yusuke Suzuki, Nagaokakyo-shi (JP); Kenji Naito, Nagaokakyo-shi (JP)

(21) Appl. No.: 16/673,098

(22) Filed: Nov. 4, 2019

Related U.S. Application Data
(63) Continuation of application No. PCT/JP2018/015691, filed on Apr. 16, 2018.

(30) Foreign Application Priority Data
May 18, 2017 (JP) 2017-099086

(51) Int. Cl. H01F 41/12; H01F 27/26; H01F 27/32

(52) U.S. Cl. CPC H01F 41/125; H01Q 7/00; H01F 27/325; H01F 27/266

(57) ABSTRACT

A method for manufacturing a ferrite-core fixing structure that includes preparing a ferrite core, preparing a bobbin that is a cylindrical member having a first end portion and a second end portion, the first end portion having an opening sized to receive the ferrite core, and the second end portion being at least partially closed, the bobbin being longer than the ferrite core in an axial direction of the bobbin, inserting the ferrite core into the bobbin through the opening, and fixing the ferrite core into the bobbin by heating and softening the first end portion of the bobbin and by pressing, using a pressing die, the first end portion of the bobbin in the axial direction such that the first end portion of the bobbin is melt-bonded.

### CROSS REFERENCE TO RELATED APPLICATIONS

The present application is a continuation of International application No. PCT/JP2018/015691, filed Apr. 16, 2018, which claims priority to Japanese Patent Application No. 2017-099086, filed May 18, 2017, the entire contents of each of which are incorporated herein by reference.

### FIELD OF THE INVENTION

The present invention relates to a ferrite-core fixing structure and a method for manufacturing the ferrite-core fixing structure.

### BACKGROUND OF THE INVENTION

In the related art, a ferrite-core fixing structure formed by accommodating a ferrite core in a cylindrical case member is known (see, for example, Patent Document 1).

According to Patent Document 1, two resin sheets are arranged on outer side portions of a ferrite core, and the resin sheets are pressed against the ferrite core by using pressing dies. Each of the resin sheets contains a curing agent, and the pressing dies are heated. By heating and curing the resin sheets, a case member that covers the ferrite core such that the ferrite core is fixed in place is formed. In this manner, a ferrite-core fixing structure is manufactured.

Patent Document 1: Japanese Unexamined Patent Application Publication No. 2005-135948

### SUMMARY OF THE INVENTION

However, according to the method for manufacturing a ferrite-core fixing structure described in Patent Document 1, it takes a long time to cure the resin sheets, and it can be said that there is still room for improvement in terms of productivity in manufacturing a ferrite-core fixing structure.

Accordingly, it is an object of the present invention to solve the above-mentioned problem and to provide a method for manufacturing a ferrite-core fixing structure, the method being capable of improving productivity, and a ferrite-core fixing structure manufactured by the method.

To achieve the above-mentioned object, a method for manufacturing a ferrite-core fixing structure according to the present invention includes preparing a ferrite core, preparing a bobbin that is a cylindrical member having a first end portion and a second end portion, the first end portion having an opening sized to receive the ferrite core, and the second end portion being at least partially closed, the bobbin being longer than the ferrite core in an axial direction of the bobbin, inserting the ferrite core into the bobbin through the opening, and fixing the ferrite core into the bobbin by heating and softening the first end portion of the bobbin and by pressing, using a pressing die, the first end portion of the bobbin in the axial direction such that the first end portion of the bobbin is melt-bonded so as to enclose the ferrite core in the bobbin.

In addition, a ferrite-core fixing structure according to the present invention includes a ferrite core and a bobbin that is a cylindrical member in which the ferrite core is accommodated and that is longer than the ferrite core in an axial direction of the bobbin, and an end portion of the bobbin includes a melt-bonded portion enclosing the ferrite core within the bobbin.

According to a method for manufacturing a ferrite-core fixing structure of the present invention and a ferrite-core fixing structure manufactured by the method, productivity can be improved.

### BRIEF DESCRIPTION OF THE DRAWINGS

FIG. 1A is a schematic perspective view illustrating a state where a ferrite-core fixing structure according to a first embodiment of the present invention has not yet undergone heating and melt-bonding operations.

FIG. 1B is a schematic perspective view illustrating a state where the ferrite-core fixing structure according to the first embodiment has undergone the heating and melt-bonding operations.

FIG. 2A is a diagram illustrating a method for manufacturing a ferrite-core fixing structure according to the first embodiment.

FIG. 2B is another diagram illustrating the method for manufacturing a ferrite-core fixing structure according to the first embodiment.

FIG. 2C is another diagram illustrating the method for manufacturing a ferrite-core fixing structure according to the first embodiment.

FIG. 2D is another diagram illustrating the method for manufacturing a ferrite-core fixing structure according to the first embodiment.

FIG. 2E is another diagram illustrating the method for manufacturing a ferrite-core fixing structure according to the first embodiment.

FIG. 2F is another diagram illustrating the method for manufacturing a ferrite-core fixing structure according to the first embodiment.

FIG. 3A is a sectional view illustrating a schematic configuration of a ferrite-core fixing structure according to a first example of the related art.

FIG. 3B is sectional view illustrating a schematic configuration of a ferrite-core fixing structure according to a second example of the related art.

FIG. 4A is a perspective view illustrating a state where the ferrite-core fixing structure according to the first embodiment has not yet undergone the heating and melt-bonding operations.

FIG. 4B is a perspective view illustrating a state where the ferrite-core fixing structure according to the first embodiment has undergone the heating and melt-bonding operations.

FIG. 5A is a perspective view of a pressing die according to the first embodiment.

FIG. 5B is a cross-sectional view of the pressing die according to the first embodiment.

FIG. 6 is a graph illustrating experimental results.

FIG. 7A is a perspective view illustrating a schematic configuration of a ferrite-core fixing structure according to a second embodiment.

FIG. 7B is another perspective view illustrating the schematic configuration of the ferrite-core fixing structure according to the second embodiment.

FIG. 8A is a perspective view illustrating a schematic configuration of a ferrite-core fixing structure according to a third embodiment.

FIG. 8B is another perspective view illustrating the schematic configuration of the ferrite-core fixing structure according to the third embodiment.

### DETAILED DESCRIPTION OF THE PREFERRED EMBODIMENTS

According to a first aspect of the present invention, a method for manufacturing a ferrite-core fixing structure is provided that includes the steps of preparing a ferrite core; preparing a bobbin that is longer than the ferrite core in the axial direction thereof and that is a cylindrical member having a first end portion and a second end portion, the first end portion having an opening into which the ferrite core is inserted, and the second end portion being at least partially closed; inserting the ferrite core into the bobbin through the opening; and fixing the ferrite core into the bobbin by heating and softening the first end portion of the bobbin and by pressing, using a pressing die, the first end portion of the bobbin in the axial direction such that the first end portion of the bobbin is melt-bonded.

According to such a method, a ferrite core can be fixed in place in a short time, and the productivity in manufacturing a ferrite-core fixing structure can be improved.

According to a second aspect of the present invention, the fixing of the ferrite core into the bobbin includes melt-bonding the first end portion of the bobbin by simultaneously cooling and pressing the first end portion of the bobbin with the pressing die. According to such a method, a melt-bonding step can be completed quicker than in the case where a cooling operation is not performed by using a pressing die, and thus, the productivity in manufacturing a ferrite-core fixing structure can be improved.

According to a third aspect of the present invention, a protrusion is formed on a contact surface of the pressing die that comes into contact with the bobbin and the fixing of the ferrite core into the bobbin includes performing a melt-bonding operation in a state where the protrusion of the pressing die is in contact with the ferrite core. According to such a method, a melt-bonding operation can be performed while maintaining a certain distance between a pressing die and a ferrite core. Thus, the thickness of an end portion of a bobbin that is to be melt-bonded can be made uniform, and a ferrite-core fixing structure having a more uniform quality can be manufactured.

According to a fourth aspect of the present invention, the fixing of the ferrite core into the bobbin includes heating and softening the first end portion of the bobbin by infrared heating. According to such a method, an end portion of a bobbin can be more intensively heated, and thus, a ferrite-core fixing structure having a more uniform quality can be manufactured.

According to a fifth aspect of the present invention, the preparing of the bobbin includes preparing the bobbin having a first end portion that is inclined toward the opening and inward in the radial direction of the bobbin. According to such a method, an end portion of a bobbin can be melt-bonded while it is caused to easily fall toward the center side, and thus, a ferrite core can be further strongly fixed in place by a melt-bonded portion.

According to a sixth aspect of the present invention, the preparing of the bobbin includes preparing the bobbin so that has the first end portion is shaped to project from an entire edge of the bobbin in a circumferential direction of the bobbin. According to such a method, when an end portion of a bobbin is melt-bonded, a ferrite core can be further strongly fixed in place.

According to a seventh aspect of the present invention, the preparing of the bobbin includes preparing the bobbin so that the first end portion has a uniform width over the entire edge of the bobbin in the circumferential direction. According to such a method, when an end portion of a bobbin is heated, the end portion of the bobbin can be more uniformly heated and softened, and thus, a ferrite-core fixing structure having a uniform quality can be manufactured.

According to an eighth aspect of the present invention, the contact surface of the pressing die that comes into contact with the bobbin forms a curved recess and the fixing of the ferrite core into the bobbin includes melt-bonding the first end portion of the bobbin by pressing the bobbin in the axial direction in a state where the first end portion of the bobbin is in contact with a curved portion of the curved recess of the pressing die. According to such a method, an end portion of a bobbin can be melt-bonded while it is caused to easily fall toward the center side, and thus, a ferrite core can be further strongly fixed in place by a melt-bonded portion.

According to a ninth aspect of the present invention, the ferrite-core fixing structure is used as an antenna coil.

According to such a method, an antenna coil can be manufactured in a shorter time, and the productivity in manufacturing an antenna coil can be improved.

According to a tenth aspect of the present invention, a ferrite-core fixing structure is provided that includes a ferrite core and a bobbin that is a cylindrical member in which the ferrite core is accommodated and that is longer than the ferrite core in the axial direction thereof, the bobbin having an end portion that includes a melt-bonded portion enclosing the ferrite core within the bobbin. According to such a configuration, a ferrite-core fixing structure can be manufactured by a highly productive manufacturing method that employs melt bonding.

According to an eleventh aspect of the present invention, the melt-bonded portion of the bobbin has an opening extending through the melt-bonded portion in the axial direction of the bobbin. According to such a configuration, an opening can be used as an insertion hole or the like for holding a ferrite-core fixing structure in a subsequent process, and convenience can be improved.

Embodiments of the present invention will be described in detail below with reference to the drawings.

### First Embodiment

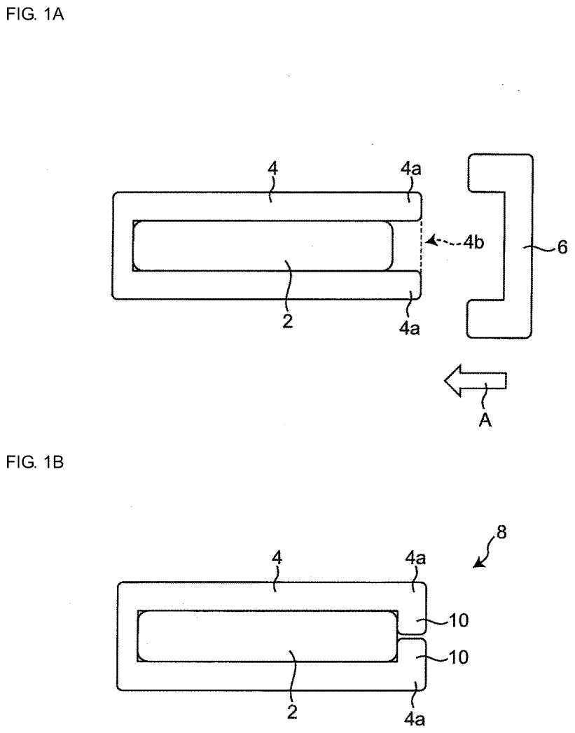

A ferrite-core fixing structure and a method for manufacturing the ferrite-core fixing structure according to the first embodiment will be schematically described with reference to FIG. 1A and FIG. 1B. FIG. 1A and FIG. 1B are schematic perspective views each illustrating the configuration of the ferrite-core fixing structure according to the first embodiment. FIG. 1A illustrates a state where heating and melt-bonding operations have not yet been performed, and FIG. 1B illustrates a state where the heating and melt-bonding operations have been performed.

As illustrated in FIG. 1A, a ferrite core 2 is accommodated in a bobbin 4 that has a cylindrical shape. In this state, an end portion 4a of the bobbin 4 is heated and softened. The softened end portion 4a is pressed in an axial direction A of the bobbin 4 using a pressing die (a punch) 6 so as to be melt-bonded around the end of the ferrite core 2. As a result, a ferrite-core fixing structure 8 in which the ferrite core 2 is fixed in the bobbin 4 as illustrated in FIG. 1B can be manufactured. In the ferrite-core fixing structure 8, the ferrite core 2 is fixed in place by a melt-bonded portion (melt-bonded connecting portion) 10 that is formed at the end portion 4a of the bobbin 4.

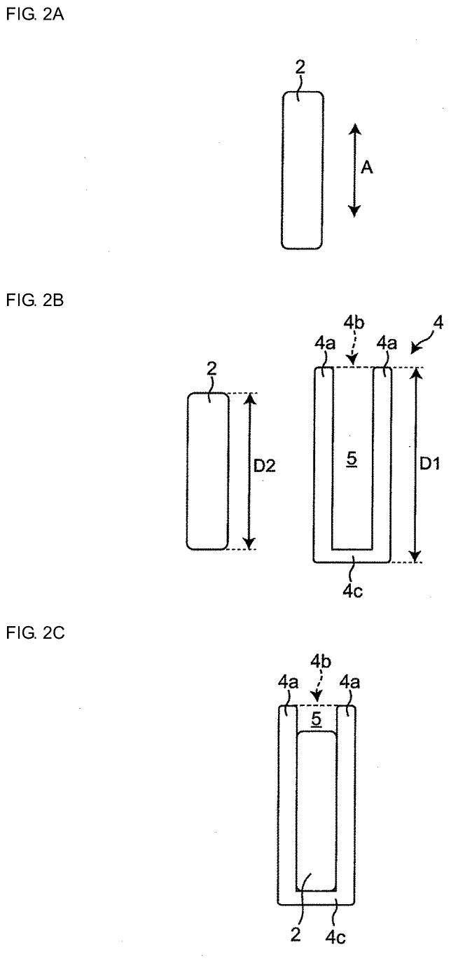

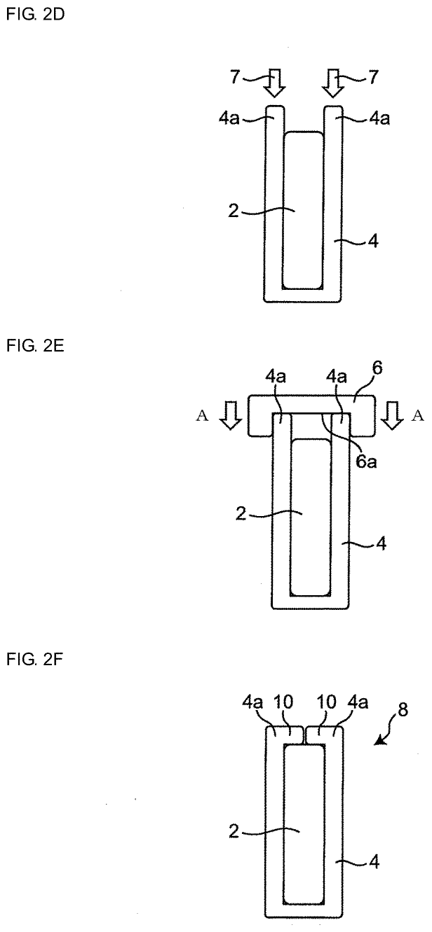

A more specific method for manufacturing the above-described ferrite-core fixing structure 8 will now be described with reference to FIG. 2A to FIG. 2F.

First, the ferrite core 2 is prepared (step S1). More specifically, as illustrated in FIG. 2A, a ferrite core 2 that extends in the axial direction A is prepared. The term “ferrite core” refers to a magnetic member made of ferrite. For example, a ferrite core is used as an antenna-coil component for an automobile keyless entry system.

In the first embodiment, the shape of the ferrite core 2 is an elongated rod-like shape extending in the axial direction A. However, the shape of the ferrite core 2 is not limited to such a shape and may be arbitrary.

Next, the bobbin 4 is prepared (step S2). More specifically, as illustrated in FIG. 2B, a bobbin 4 that has a cylindrical shape is prepared. The term “bobbin” refers to a cylindrical case member in which a ferrite core is accommodated. In the bobbin 4 illustrated in FIG. 2B, the first end portion 4a is open so as to form an opening 4b. The opening 4b is an opening through which the above-described ferrite core 2 can be inserted into an internal space 5 of the bobbin 4. A second end portion 4c of the bobbin 4 is closed.

A length D1 of the bobbin 4 in the axial direction A is longer than a length D2 of the ferrite core 2 in the axial direction A. Thus, the entire ferrite core 2 can be accommodated in the internal space 5 of the bobbin 4.

A material of the bobbin 4 is, for example, polybutylene terephthalate (PBT) resin.

Next, the ferrite core 2 is inserted into the bobbin 4 (step S3). More specifically, the ferrite core 2 is inserted into the bobbin 4 through the opening 4b of the bobbin 4. As a result, as illustrated in FIG. 2C, the ferrite core 2 is inserted into the internal space 5 of the bobbin 4. The ferrite core 2 is engaged with the second end portion 4c in the internal space 5. In this case, the end portion 4a of the bobbin 4 projects outward further than the ferrite core 2 does.

Next, the end portion 4a of the bobbin 4 is heated and softened (step S4). More specifically, the end portion 4a of the bobbin 4, which projects outward further than the ferrite core 2 does, is heated and softened.

In the first embodiment, as illustrated in FIG. 2D, the end portion 4a of the bobbin 4 is heated by using infrared rays 7. Since infrared heating has higher heat directivity compared to that of heating using a heater, a burner, or the like, the end portion 4a of the bobbin 4 can be more intensively heated.

Next, the end portion 4a of the bobbin 4 is melt-bonded (step S5). Specifically, the end portion 4a of the bobbin 4, which has been softened in step S4, is pressed in the axial direction A by using the pressing die 6 as illustrated in FIG. 2E. More specifically, in a state where a contact surface 6a of the pressing die 6 that faces the bobbin 4 is in contact with the end portion 4a of the bobbin 4, the pressing die 6 is pressed down in the axial direction A. As a result, the end portion 4a of the bobbin 4 is deformed and melt-bonded as illustrated in FIG. 2F.

The contact surface 6a of the pressing die 6 forms a recess that surrounds the end portion 4a of the bobbin 4. The melt-bonding process in step S5 is performed by using the above-described pressing die 6, so that the end portion 4a of the bobbin 4 is inclined inward, and the melt-bonded portion 10 such as that illustrated in FIG. 2F is formed.

Here, in the melt-bonding process in step S5 of the first embodiment, the pressing die 6 is not heated, and the temperature of the contact surface 6a of the pressing die 6 is set to around a room temperature (e.g., about 30° C.). In contrast, the end portion 4a of the bobbin 4, which has been softened in step S4, has a temperature (e.g., about 200° C.) higher than a room temperature. In this manner, by setting the temperature of the contact surface 6a of the pressing die 6 to be lower than the temperature of the end portion 4a of the bobbin 4, the end portion 4a of the bobbin 4 is pressed and cooled simultaneously.

According to such a method, the end portion 4a of the bobbin 4 can be quickly cooled, so that the melt bonding can be quickly completed compared with the case where the pressing die 6 is heated, and the end portion 4a of the bobbin 4 is pressed and heated simultaneously. In addition, in the case where the pressing die 6 is heated, when the pressing die 6 is pulled up, the end portion 4a of the bobbin 4 may easily deform as a result of being pulled by the contact surface 6a of the pressing die 6, whereas such a shape change can be prevented in the first embodiment. Furthermore, deformation of the pressing die 6 can be suppressed by not heating the pressing die 6, and the service life of the pressing die 6 can be extended.

In the ferrite-core fixing structure 8 illustrated in FIG. 2F, the ferrite core 2 is fixed in the bobbin 4 by the melt-bonded portion 10 of the bobbin 4. There is physically no gap at the interface between the melt-bonded portion 10 and the ferrite core 2 that are in contact with each other, and the melt-bonded portion 10 and the ferrite core 2 are not integrated with each other by, for example, being “fuse-bonded together”.

As described above, the ferrite core 2 is fixed in place by the melt-bonded portion 10 which is formed by heating the end portion 4a of the bobbin 4, so that the ferrite-core fixing structure 8 can be manufactured more quickly and easily compared with the related art in which a ferrite core is fixed in place by using a sealing resin containing a curing agent.

In the ferrite-core fixing structure 8 that is manufactured by the above-described method, it can be confirmed, on the basis of, for example, a melt-bonded mark that is generated as a result of melt bonding, that the melt-bonded portion 10 is formed by being actually melt-bonded.

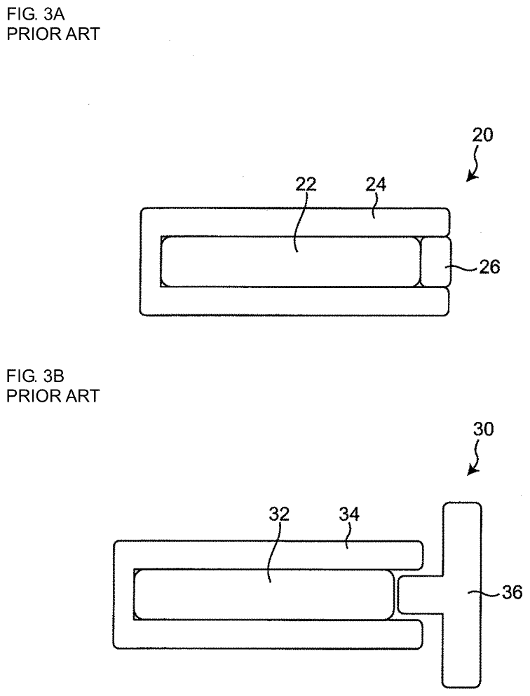

Here, a ferrite-core fixing structure in which a ferrite core is fixed in a bobbin by using a sealing resin containing a curing agent is illustrated in FIG. 3A (a first example of the related art). In addition, as another example of the related art, a ferrite-core fixing structure in which a ferrite core is fixed in a bobbin by placing a pressing member such that the pressing member covers an opening of a bobbin is illustrated in FIG. 3B (a second example of the related art).

As illustrated in FIG. 3A, in a ferrite-core fixing structure 20 according to the first example of the related art, an opening of a bobbin 24 is sealed by a sealing resin 26 in a state where a ferrite core 22 is inserted in the bobbin 24. For example, a silicon-based resin is used as the sealing resin 26.

As illustrated in FIG. 3B, in a ferrite-core fixing structure 30 according to the second example of the related art, an opening of a bobbin 34 is sealed by a pressing member 36 in a state where a ferrite core 32 is inserted in the bobbin 34. For example, there is a case where a portion of a case (not illustrated) that covers the bobbin 34 is configured to serve as the pressing member 36.

As in the first example of the related art, in the case of employing the method using the sealing resin 26 containing a curing agent, it is necessary to leave a ferrite-core fixing structure for a long period of time (e.g., about half a day) in order to cure the curing agent. In contrast, in the method according to the first embodiment, the heating operation using the infrared rays 7 and the pressing and melt-bonding operations using the pressing die 6 can be performed in, for example, about 10 seconds. In this manner, the ferrite-core fixing structure 8 can be manufactured very quickly, and the productivity can be significantly improved.

In addition, according to the method of the first embodiment, a chemical substance such as a curing agent is not necessary, and thus, the method is not influenced by the regulation of chemical substances.

Furthermore, an additional member such as the pressing member 36 in the second example of the related art is not necessary. Thus, the number of components can be reduced, and the manufacturing costs of a ferrite-core fixing structure can be reduced.

In the ferrite-core fixing structure 30 according to the second example of the related art, when vibration or stress is applied to a case (not illustrated) forming the pressing member 36, the vibration or the stress may sometimes be transmitted to the ferrite core 32 in the bobbin 34, which in turn results in breakage of the ferrite core 32. In contrast, in the method according to the first embodiment, even if vibration or stress is applied to a case (not illustrated) that accommodates the bobbin 4, the vibration or the stress will not be directly transmitted to the ferrite core 2, and thus, breakage of the ferrite core 2 can be suppressed.

In addition, according to the method of the first embodiment, the ferrite core 2 can be fixed in place by a single component, which is the bobbin 4, and thus, a disturbance factor can be eliminated.

After the ferrite-core fixing structure 8 has been manufactured, a metal wire is wound around the bobbin 4, so that the ferrite-core fixing structure 8 can be used as, for example, an antenna coil for an automobile keyless entry system. Since the ferrite core 2 is strongly fixed in the bobbin 4, the ferrite core 2 and the metal wire wound around the bobbin 4 are less likely to be displaced from each other, and the ferrite-core fixing structure 8 can be used as an antenna coil having desired characteristics.

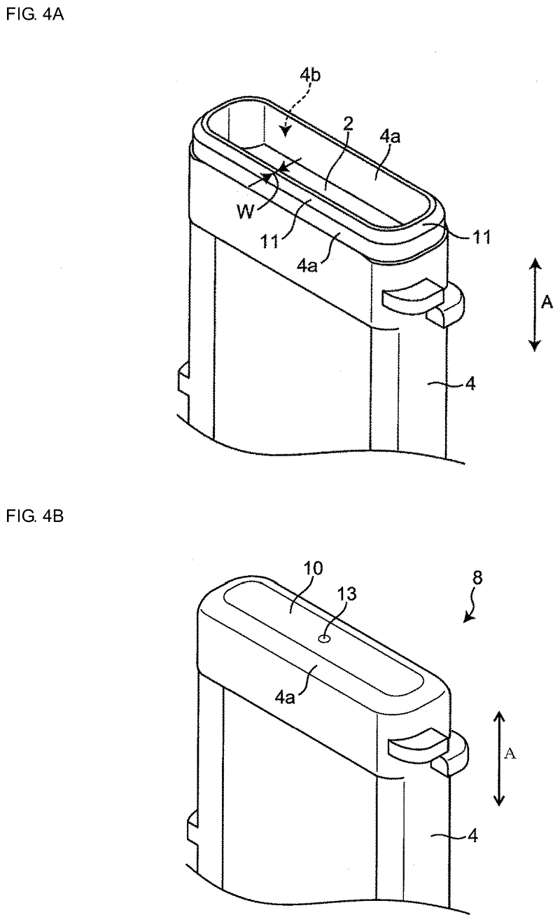

The ferrite-core fixing structure 8, which has been described above with reference to FIG. 2A to FIG. 2F, will now be described in further detail with reference to FIG. 4A and FIG. 4B. FIG. 4A is a perspective view illustrating a state where the ferrite core 2 has been inserted in the bobbin 4, and the heating and melt-bonding operations have not yet been performed, and FIG. 4B is a perspective view illustrating a state where the heating and melt-bonding operations have been performed.

As illustrated in FIG. 4A, the end portion 4a of the bobbin 4 according to the first embodiment is inclined toward the opening 4b and toward the center side of the bobbin 4 (the inner side in a radial direction). In other words, an outer side portion of the end portion 4a of the bobbin 4 forms an inclined surface 11. According to such a configuration, in step S5 in which the above-described pressing and melt-bonding operations using the pressing die 6 are performed, when the end portion 4a of the bobbin 4 is pressed in the axial direction A by the pressing die 6, the end portion 4a of the bobbin 4 can be caused to easily fall toward the center side. This facilitates formation of the melt-bonded portion 10, which is formed by causing the end portion 4a of the bobbin 4 to fall toward the center side, as illustrated in FIG. 4B, and the ferrite core 2 can be further strongly fixed in place.

In addition, as illustrated in FIG. 4A, the end portion 4a of the bobbin 4 according to the first embodiment projects in the axial direction A from an edge of the bobbin 4, which is a cylindrical member, so as to continuously extend over the entire edge in the circumferential direction of the bobbin 4. According to such a configuration, as illustrated in FIG. 4B, the melt-bonded portion 10 can be formed so as to extend over the entire edge of the bobbin 4 in the circumferential direction, and thus, the ferrite core 2 can be further strongly fixed in place.

In addition, as illustrated in FIG. 4A, the end portion 4a of the bobbin 4 according to the first embodiment has a uniform width W over the entire edge of the bobbin 4 in the circumferential direction. According to such a configuration, in step S4 in which the end portion 4a of the bobbin 4 is heated and softened as described above, the end portion 4a of the bobbin 4 can be softened more uniformly. As a result, compared with the case where the width of the end portion 4a of the bobbin 4 is nonuniform, the shape of the melt-bonded portion 10 of the bobbin 4 after the melt-bonding operation can be made uniform, and the ferrite-core fixing structure 8 having a uniform quality can be manufactured.

Note that the term “uniform width” may include manufacturing errors, and for example, any width value that is within a range of ±10% of the width W, which is a reference value, may be included in the uniform width.

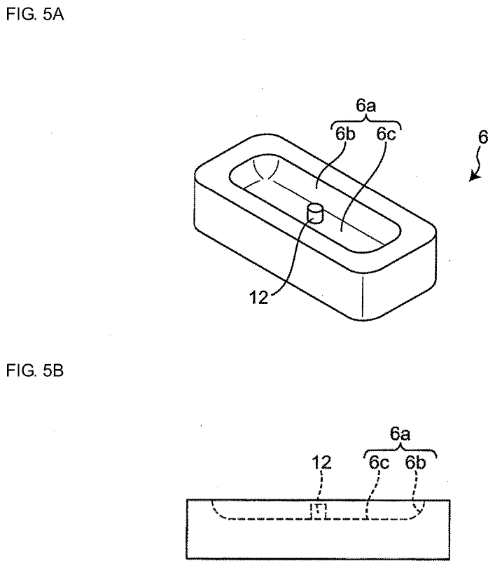

Next, the configuration of the pressing die 6 that is used in step S5 will be described in further detail with reference to FIG. 5A and FIG. 5B. FIG. 5A is a perspective view of the pressing die 6, and FIG. 5B is a cross-sectional view of the pressing die 6.

As illustrated in FIG. 5A, the contact surface 6a of the pressing die 6 includes a curved portion 6b and a flat surface portion 6c that extends flat.

The curved portion 6b is a portion that is brought into contact with the end portion 4a of the bobbin 4 in step S5, in which the above-described pressing and melt-bonding operations using the pressing die 6 are performed. By bringing the curved portion 6b into contact with the end portion 4a of the bobbin 4, when the end portion 4a of the bobbin 4 is pressed in the axial direction A by the pressing die 6, the end portion 4a of the bobbin 4 can be caused to further easily fall toward the inner side in the radial direction. As a result, the ferrite core 2 can be further strongly fixed in place.

In addition, in the first embodiment, a protrusion 12 is formed at the center of the flat surface portion 6c. The protrusion 12 is a portion that is brought into contact with the ferrite core 2 in the bobbin 4 in step S5, in which the above-described pressing and melt-bonding operations using the pressing die 6 are performed. In the first embodiment, in step S5, the melt-bonding operation is performed in a state where the protrusion 12 of the pressing die 6 is in contact with the ferrite core 2. According to such a method, the melt-bonding operation can be performed while maintaining a certain distance between the pressing die 6 and the ferrite core 2. As a result, the thickness of the end portion 4a of the bobbin 4 between the pressing die 6 and the ferrite core 2 can be controlled, and the thickness of the melt-bonded portion 10 after the melt-bonding operation can be made uniform. Therefore, the ferrite-core fixing structure 8 having a more uniform quality can be manufactured.

The melt-bonding operation in step S5 is performed by using the above-mentioned protrusion 12, so that a hole 13 is formed in the ferrite-core fixing structure 8 that is manufactured as illustrated in FIG. 4B. The hole 13 is a hole that is formed at a position corresponding to the protrusion 12 and extends through the end portion 4a in the axial direction A. By forming the above-mentioned hole 13, for example, the hole 13 may be used in an inspection process that is to be subsequently performed as a hole into which a pin for keeping the position of the ferrite-core fixing structure 8 is inserted, and accordingly, the convenience of inspection can be improved.

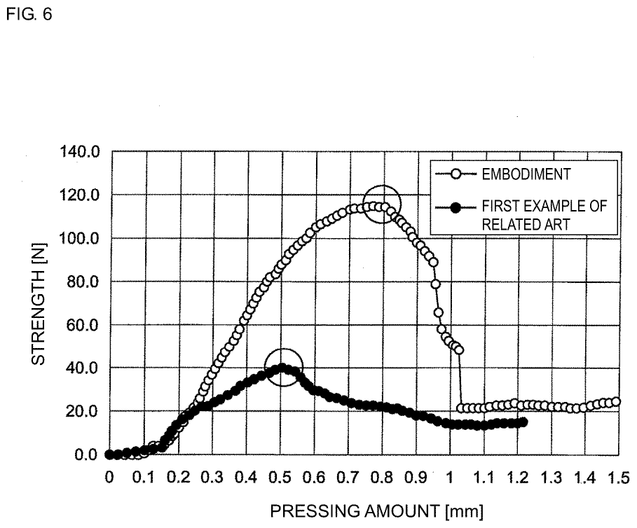

The inventors of the present invention conducted an experiment that is related to the strength of the ferrite-core fixing structure 8 manufactured by the manufacturing method according to the above-described first embodiment. More specifically, in the ferrite-core fixing structure 8 illustrated in FIG. 4B, the second end portion 4c of the bobbin 4 was opened so as to expose the ferrite core 2 at the second end portion 4c, and an end portion of the ferrite core 2 that was exposed was pressed toward the first end portion 4a of the bobbin 4 (the melt-bonded portion 10). The strength until the melt-bonded portion 10 of the bobbin 4 was broken was measured by gradually increasing the pressing force. The experimental result is illustrated in FIG. 6.

FIG. 6 illustrates the experimental result related to the ferrite-core fixing structure 8 according to the above-described first embodiment and an experimental result obtained by conducting a similar experiment on the above-described ferrite-core fixing structure 20 according to the first example of the related art. In FIG. 6, the horizontal axis denotes “pressing amount (mm)” that is the amount of movement when the second end portion of the bobbin is pressed in the axial direction A, and the vertical axis denotes “strength (N)” that is the stress that the ferrite core fixing structure receives from the bobbin as a result of pressing the bobbin.

As illustrated in FIG. 6, in the ferrite-core fixing structure 20 according to the first example of the related art, the melt-bonded portion 10 was broken when the pressing amount was about 0.5 mm, and the strength was about 40 N. In contrast, in the ferrite-core fixing structure 8 according to the embodiment, the melt-bonded portion 10 was broken when the pressing amount was about 0.8 mm, and the strength was about 115 N. As mentioned above, it was shown that the ferrite-core fixing structure 8 according to the first embodiment have a strength about three times as large as the strength of the ferrite-core fixing structure 20 according to the first example of the related art.

### Second Embodiment

A ferrite-core fixing structure according to a second embodiment of the present invention will now be described. Note that, in the second embodiment, a difference from the first embodiment will be mainly described. In addition, repeated descriptions will be avoided.

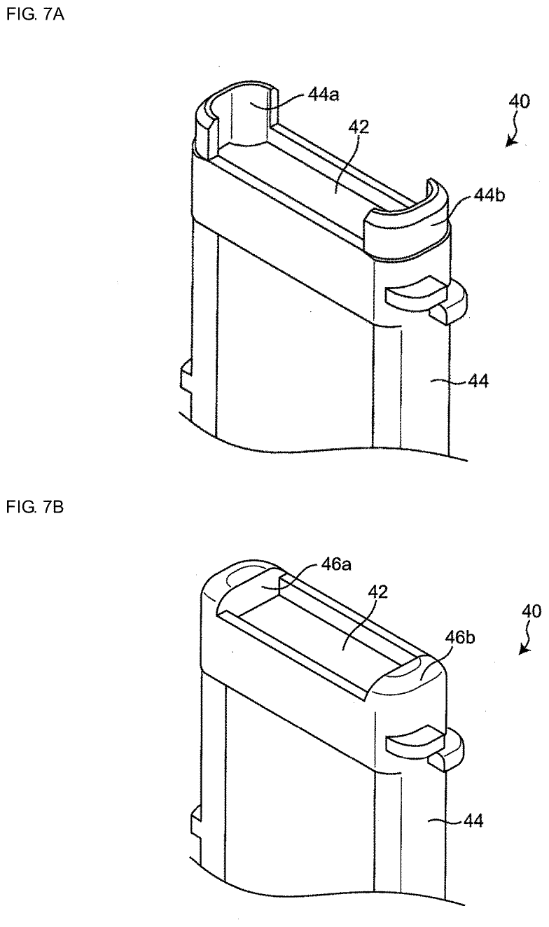

FIG. 7A and FIG. 7B are perspective views each illustrating a ferrite-core fixing structure 40 according to the second embodiment. FIG. 7A illustrates a state where the heating and melt-bonding operations have not yet been performed, and FIG. 7B illustrates a state where the heating and melt-bonding operations have been performed.

As illustrated in FIG. 7A, in a state where a ferrite core 42 is inserted in a bobbin 44, end portions 44a and 44b of the bobbin 44 each project outward further than the ferrite core 42 does. The end portions 44a and 44b of the bobbin 44 according to the second embodiment do not project from the entire edge of the bobbin 44 in the circumferential direction of the bobbin 44 and are formed only at two positions on the edge of the bobbin 44 so as to face each other as illustrated in FIG. 7A.

Similar to the above-described first embodiment, heating and softening processes (step S4) and pressing and melt-bonding processes (step S5) are performed on the above-described end portions 44a and 44b of the bobbin 44, so that the ferrite-core fixing structure 40 illustrated in FIG. 7B can be manufactured.

In the ferrite-core fixing structure 40 illustrated in FIG. 7B, the end portions 44a and 44b of the bobbin 44 are deformed by being pressed toward the center side of the bobbin 44, and melt-bonded portions 46a and 46b are formed. There is an opening between the melt-bonded portion 46a and the melt-bonded portion 46b, and an end portion of the ferrite core 42 is exposed through the opening. In such a configuration, the melt-bonded portions 46a and 46b are in close contact with the end portion of the ferrite core 42 in the bobbin 44 and strongly fix the ferrite core 42 in place.

The ferrite-core fixing structure 40 according to the second embodiment can be manufactured by using the above-described manufacturing method and steps S1 to S5 according to the first embodiment, and thus, advantageous effects similar to those of the first embodiment can be obtained.

### Third Embodiment

A ferrite-core fixing structure according to a third embodiment of the present invention will now be described.

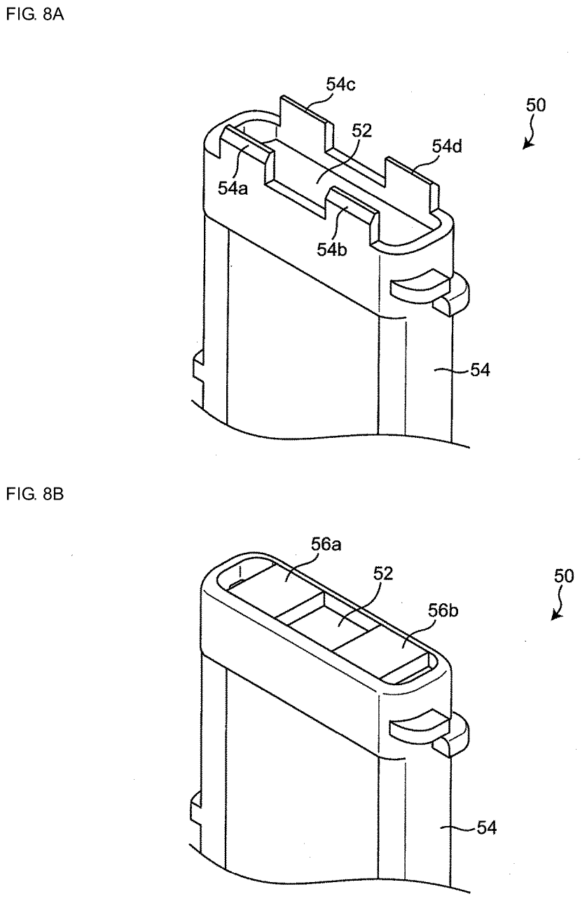

FIG. 8A and FIG. 8B are perspective views each illustrating a ferrite-core fixing structure 50 according to the third embodiment. FIG. 8A illustrates a state where the heating and melt-bonding operations have not yet been performed, and FIG. 8B illustrates a state where the heating and melt-bonding operations have been performed.

As illustrated in FIG. 8A, in a state where a ferrite core 52 is inserted in a bobbin 54, end portions 54a, 54b, 54c, and 54d of the bobbin 54 each project outward further than the ferrite core 52 does. Similar to the second embodiment, in the third embodiment, the end portions 54a, 54b, 54c, and 54d of the bobbin 54 do not project from the entire edge of the bobbin 54 in the circumferential direction of the bobbin 54 and each project from a portion of the edge in the circumferential direction. More specifically, the end portions 54a and 54b are arranged at a first side of the edge of the bobbin 54, and the end portions 54c and 54d are arranged at a second side of the edge of the bobbin 54. The end portion 54a and the end portion 54c are positioned so as to face each other, and the end portion 54b and the end portion 54d are positioned so as to face each other.

Similar to the above-described first embodiment, heating and softening processes (step S4) and pressing and melt-bonding processes (step S5) are performed on the above-described end portions 54a, 54b, 54c, and 54d of the bobbin 54, so that the ferrite-core fixing structure 50 illustrated in FIG. 8B is manufactured.

In the ferrite-core fixing structure 50 illustrated in FIG. 8B, the above-described end portions 54a, 54b, 54c, and 54d of the bobbin 54 are deformed by being pressed toward the center side of the bobbin 54, and melt-bonded portions 56a and 56b are formed. More specifically, the end portion 54a and the end portion 54c of the bobbin 54 are melt-bonded together so as to form the melt-bonded portion 56a, and the end portion 54b and the end portion 54d of the bobbin 54 are melt-bonded together so as to form the melt-bonded portion 56b. There are openings around the melt-bonded portion 56a and the melt-bonded portion 56b, and an end portion of the ferrite core 52 is exposed through these openings. Also in such a configuration, the melt-bonded portions 56a and 56b are in close contact with the ferrite core 52 in the bobbin 54 and strongly fix the ferrite core 52 in place.

Similar to the ferrite-core fixing structure 40 according to the second embodiment, the ferrite-core fixing structure 50 according to the third embodiment can be manufactured by using the above-described manufacturing method and steps S1 to S5 according to the first embodiment, and thus, advantageous effects similar to those of the first and second embodiments can be obtained.

Although the first to third embodiments of the present invention have been described above, the present invention is not limited to the above-described first to third embodiments. For example, in the first embodiment, although a case has been described in which the end portion 4a of the bobbin 4 is pressed and cooled simultaneously by using the pressing die 6 in step S5, the present invention is not limited to such a case, and the end portion 4a of the bobbin 4 may be pressed without being cooled. However, in the case where the end portion 4a of the bobbin 4 is pressed and cooled simultaneously by using the pressing die 6, the melt-bonding step can be completed quicker, and the productivity in manufacturing the ferrite-core fixing structure 8 can be improved.

In the first embodiment, although the protrusion 12 is formed on the contact surface 6a of the pressing die 6, and the operation in step S5 is performed in a state where the protrusion 12 is in contact with the ferrite core 2, the present invention is not limited to such a case, and the protrusion 12 may not be provided. However, in the case where the protrusion 12 is provided, and the melt-bonding operation is performed, the thickness of the bobbin 4 between the pressing die 6 and the ferrite core 2 can be controlled, and the thickness of the melt-bonded portion 10 after the melt-bonding operation can be made uniform.

In the first embodiment, although a case has been described in which the first end portion 4a of the bobbin 4 is heated and softened by infrared heating in step S4, the present invention is not limited to such a case, and the end portion 4a of the bobbin 4 may be heated by a heating method other than infrared heating (e.g., ultrasonic heating). However, in the case of employing infrared heating, the ferrite core 2 will not break as a result of vibration being transmitted to the ferrite core 2 unlike in the case of employing ultrasonic heating, and thus, the ferrite-core fixing structure 8 having a favorable quality can be manufactured. In addition, only the end portion 4a of the bobbin 4 may easily be heated intensively compared with the case of heating using a heater, a burner, or the like, and thus, the ferrite-core fixing structure 8 having a favorable quality can be manufactured.

In the first embodiment, although a case has been described in which the end portion 4a of the bobbin 4 is inclined toward the opening 4b and toward the center side of the bobbin 4, the present invention is not limited to such a case, and the shape of the end portion 4a may be arbitrary. However, in the case where the end portion 4a of the bobbin 4 is inclined toward the opening 4b and toward the center side of the bobbin 4, the end portion 4a can be caused to fall toward the center side when the melt-bonding operation is performed, and the ferrite core 2 can be further strongly fixed in place.

In the first embodiment, although a case has been described in which the end portion 4a of the bobbin 4 is shaped to project from the entire edge of the bobbin 4 in the circumferential direction of the bobbin 4, the present invention is not limited to such a case, and the end portion 4a of the bobbin 4 may project from a portion of the edge in the circumferential direction as in the second and third embodiments. However, in the case where the end portion 4a projects from the entire edge of the bobbin 4 in the circumferential direction, the ferrite core 2 can be strongly fixed in place by the melt-bonded portion 10.

In the first embodiment, although a case has been described in which the end portion 4a of the bobbin 4 has a uniform width over the entire edge of the bobbin 4 in the circumferential direction, the present invention is not limited to such a case, and the width of the end portion 4a of the bobbin 4 may be nonuniform. However, in the case where the end portion 4a of the bobbin 4 has a uniform width, the shape of the melt-bonded portion 10 after the melt-bonding operation can be made uniform, and the ferrite-core fixing structure 8 having a uniform quality can be manufactured.

In the first embodiment, although a case has been described in which the contact surface 6a of the pressing die 6 forms the curved recess and in which the end portion 4a of the bobbin 4 is pressed and melt-bonded in a state of being in contact with the curved portion 6b, the present invention is not limited to such a case. The shape of the contact surface 6a of the pressing die 6 may be arbitrary. However, by pressing the end portion 4a of the bobbin 4 in a state where the end portion 4a of the bobbin 4 is in contact with the curved portion 6b of the pressing die 6, which is curved and recessed, the end portion 4a of the bobbin 4 can be pressed toward the center side, and thus, the ferrite core 2 can be further strongly fixed in place.

In the first embodiment, although a case has been described in which the second end portion 4c of the bobbin 4 is completely closed, the present invention is not limited to such a case, and the second end portion 4c of the bobbin 4 may be partially closed instead of being completely closed as long as the ferrite core 2 can be engaged with the second end portion 4c.

In the first embodiment, although a case has been described in which the ferrite-core fixing structure 8 is used as an antenna coil, the present invention is not limited to such a case, and the ferrite-core fixing structure 8 may be applied to an arbitrary structure.

Although the present disclosure has been sufficiently described in association with the preferred embodiments and with reference to the accompanying drawings, various changes and modifications are apparent to those skilled in the art. It should be understood that such changes and modifications are included in the scope of the present disclosure determined by the appended claims as long as they are within the scope of the present disclosure. In addition, combinations of the components according to the embodiments and changes in the order of steps in the manufacturing methods according to the embodiments may be carried out within the scope and concept of the present disclosure.

Note that the various embodiments and modifications, which have been described above, may be arbitrarily and suitably combined with one another, so that their advantageous effects can be obtained.

The present invention is applicable to any ferrite-core fixing structure and any method for manufacturing the ferrite-core fixing structure.

### REFERENCE SIGNS LIST

2 ferrite core

4 bobbin

4a end portion (first)

4b opening

4c end portion (second)

5 internal space

6 pressing die (punch)

7 infrared rays

8 ferrite-core fixing structure

10 melt-bonded portion

11 inclined surface

12 protrusion

20 ferrite-core fixing structure

22 ferrite core

24 bobbin

24a opening

26 sealing resin

30 ferrite-core fixing structure

32 ferrite core

34 bobbin

34a opening

36 pressing member

40 ferrite-core fixing structure

42 ferrite core

44 bobbin

44a, 44b end portion

46a, 46b melt-bonded portion

50 ferrite-core fixing structure

52 ferrite core

54 bobbin

54a, 54b, 54c, 54d end portion

56a, 56b melt-bonded portion

1. A method for manufacturing a ferrite-core fixing structure comprising:
preparing a ferrite core;
preparing a bobbin that is a cylindrical member having a first end portion and a second end portion, the first end portion having an opening sized to receive the ferrite core, and the second end portion being at least partially closed, the bobbin being longer than the ferrite core in an axial direction of the bobbin;
inserting the ferrite core into the bobbin through the opening; and
fixing the ferrite core into the bobbin by heating and softening the first end portion of the bobbin and by pressing, using a pressing die, the first end portion of the bobbin in the axial direction such that the first end portion of the bobbin is melt-bonded so as to enclose the ferrite core in the bobbin.

2. The method for manufacturing a ferrite-core fixing structure according to claim 1, wherein the fixing of the ferrite core into the bobbin includes simultaneously cooling and pressing the first end portion of the bobbin with the pressing die.

3. The method for manufacturing a ferrite-core fixing structure according to claim 1,
wherein the pressing dies includes a protrusion on a contact surface thereof that comes into contact with the bobbin, and
wherein the fixing of the ferrite core into the bobbin is conducted such that the protrusion of the pressing die is in contact with the ferrite core.

4. The method for manufacturing a ferrite-core fixing structure according to claim 1, wherein the heating and softening the first end portion of the bobbin is carried out by infrared heating.

5. The method for manufacturing a ferrite-core fixing structure according to claim 1, wherein the preparing of the bobbin includes preparing the first end portion of the bobbin to be inclined toward the opening and inward in a radial direction of the bobbin.

6. The method for manufacturing a ferrite-core fixing structure according to claim 1, wherein the preparing of the bobbin includes preparing the first end portion of the bobbin to be shaped so as to project from an entire edge of the bobbin in a circumferential direction of the bobbin.

7. The method for manufacturing a ferrite-core fixing structure according to claim 6, wherein the preparing of the bobbin includes preparing the first end portion to have a uniform width over the entire edge of the bobbin in the circumferential direction.

8. The method for manufacturing a ferrite-core fixing structure according to claim 1,
wherein a contact surface of the pressing die which comes into contact with the bobbin is in the form of a curved recess, and
wherein the fixing of the ferrite core into the bobbin includes pressing the bobbin in the axial direction in a state where the first end portion of the bobbin is in contact with a surface of the curved recess of the pressing die.

9. The method for manufacturing a ferrite-core fixing structure according to claim 1, further comprising configuring the ferrite-core fixing structure for use as an antenna coil.

10. A ferrite-core fixing structure comprising:
a ferrite core; and
a bobbin that is a cylindrical member in which the ferrite core is accommodated and that is longer than the ferrite core in an axial direction of the bobbin, and wherein an end portion of the bobbin includes a melt-bonded portion enclosing the ferrite core within the bobbin.

11. The ferrite-core fixing structure according to claim 10, wherein the melt-bonded portion of the bobbin has an opening extending through the melt-bonded portion in the axial direction of the bobbin.

12. The ferrite-core fixing structure according to claim 10, wherein a material of the bobbin is polybutylene terephthalate resin.

13. The ferrite-core fixing structure according to claim 10, further comprising a metal wire wound around the bobbin.

14. The ferrite-core fixing structure according to claim 10, wherein the melt-bonded portion extends over the entire end portion of the bobbin.

15. The ferrite-core fixing structure according to claim 10, wherein the melt-bonded portion is a first melt-bonded portion, and the ferrite-core fixing structure further comprises a second melt-bonded portion on the end portion of the bobbin, the first melt-bonded portion and the second melt-bonded portion being spaced from each other.

16. The ferrite-core fixing structure according to claim 15, wherein the first melt-bonded portion and the second melt-bonded portion define an opening therebetween, the ferrite core being exposed through the opening.

17. The ferrite-core fixing structure according to claim 15, wherein openings are defined around each of the first melt-bonded portion and the second melt-bonded portion, and the ferrite core is exposed through the openings.
